(19) United States
(12) Patent Application Publication
(10) Pub. No.: US 2020/0130244 A1
(43) Pub. Date: Apr. 30, 2020

(54) Glass Molded Product

(71) Applicant: Futaba Corporation, Mobara-shi (JP)

(72) Inventor: Takashi Inoue, Mobara-shi (JP)

(21) Appl. No.: 16/599,981

(22) Filed: Oct. 11, 2019

(30) Foreign Application Priority Data
Oct. 24, 2018 (JP) 2018-200007

(51) Int. Cl. B29C 45/14; G02F 1/1333; C03C 17/32

(52) U.S. Cl. CPC B29C 45/14434; G02F 1/133308; C03C 17/322; B29K 2075/00; C03C 2217/485; C03C 2217/445; G02F 2001/133331

(57) ABSTRACT

A glass molded product includes: a plate-like glass having a convex portion provided on an outer peripheral end face; and a frame made of resin which covers the convex portion and is provided by integral molding and which is flush with front and back surfaces of the plate-like glass; and a colored layer provided on the convex portion. Looking at the frame through the plate-like glass from a front side of the plate-like glass, the colored layer of the convex portion is observed as a background of the diffuse reflection which occurs at the boundary between the convex portion of the plate-like glass and the frame. Therefore, the color of the colored layer makes the diffuse reflection less noticeable and improves an appearance.

### TECHNICAL FIELD

The present invention relates to a glass molded product in which a resin frame is integrally formed on an outer peripheral end face of a plate-like glass.

### BACKGROUND ART

Patent Literature 1 below describes an invention of a glass article having an outer coating of a polymer and a method of forming the same. This glass article comprises a molded glass substrate including a first surface, a second surface, and a peripheral edge. This molded glass substrate is formed of tempered glass with a compressive stress layer that resists surface damage without forming cracks. The outer coating of the polymer is connected with the connection mechanism of the peripheral edge of the molded glass substrate, thereby protecting the peripheral edge of the molded glass substrate from damage. At least a portion of the peripheral edge of the molded glass substrate may be provided with an offset of the connection mechanism from the first surface. Further, the outer coating of the polymer is intended to be integrally formed with at least one connector.

### PRIOR ART DOCUMENT

### Patent Literature

Patent Literature 1: JP 2012-526040 A

### SUMMARY OF INVENTION

### Technical Problem

The glass article described in Patent Literature 1 is a panel-like product in which an outer coating of a polymer is connected to the peripheral edge of a molded glass substrate as described above. However, on at least one of the front side and the back side of the product, a step was generated between the molded glass substrate and the outer coating. It is considered preferable to eliminate the step because the step on the front side reduces the appearance as a product, and the step on the back side is an obstacle when attaching devices such as a touch sensor, or when attaching to a substrate or frame on which the glass article is attached.

Therefore, as shown in FIG. 1, the inventor of the present application has proposed a novel glass molded product 3 in which a resin frame 2 is provided by integral molding on the outer peripheral end face of the plate-like glass 1. This glass molded product 3 is one in which a continuous rectangular frame 2 is provided on the outer peripheral end face of the rectangular plate-like glass 1. FIG. 1 is a cross-sectional view of a part of a plate-like glass 1 and a frame 2 cut at a cross section orthogonal to the surface of the plate-like glass 1. This glass molded product 3 is characterized in that there is no step between the plate-like glass 1 and the frame 2 and both the front and back surfaces are flat. In order to realize such a structural feature, in the glass molded product 3, the convex portion 4 is provided on the outer peripheral end face of the plate-like glass 1, and the plate-like glass is formed by covering the convex portion 4 with integrally formed resin. Thereby, the frame 2 is held only by the outer peripheral end face of the plate-like glass 1.

As described above, in order to stably hold the frame 2 only with the outer peripheral end face of the plate-like glass 1, it is necessary to polish the convex portion 4 of the plate-like glass 1 with a relatively rough polishing means (for example, an abrasive of about #800 or the like) to form asperities on the surface of the convex portion 4. By such processing, the molten resin at the time of integral molding intrudes into the asperities of the surface of the convex portion 4 and solidifies. Therefore, the anchor effect in which the frame 2 is fixed to the convex part 4 reliably is obtained.

However, the inventor of the present application has found that there is another problem to be solved in the glass molded product 3 in which the front surface and the back surface are made flat by such a structure. As shown by the arrow E representing the line of sight of the observer in FIG. 1, this is a problem that when the inside of the frame 2 is viewed from the front side of the glass molded product 3 through the plate-like glass 1, among the convex portions 4 of the plate-like glass 1, in particular, the slope remote from the surface side looks whitish. According to the research results by the inventor of the present application, although the resin enters the asperities of the convex portion 4 and the plate-like glass 1 and the frame 2 are in close contact, since both of them have different refractive indexes, it is considered that the light is irregularly reflected and appears white due to the asperities formed on the convex portion 4.

As described above, the present invention has been made in order to solve the additional problems known to the inventor of the present application in the invention of the inventor of the present application for solving the problems of the prior art. The object of the present invention is to improve the appearance of the inside of the frame 2 seen through the plate-like glass 1 in a novel glass molded product 3 in which a resin frame body 2 is provided by integral molding on the outer peripheral end face of the plate-like glass 1 and both the front and back surfaces are flat.

### Solution to Problem

According to a first aspect of the present invention, there is provided a glass molded product comprising: a plate-like glass with a convex portion provided on an outer peripheral end face thereof; a frame made of resin, provided by integral molding so as to cover the convex portion of the plate-like glass, and having a front surface that is flush with a front surface of the plate-like glass and a back surface that is flush with a back surface of the plate-like glass; and

a colored layer provided on the convex portion.

According to a second aspect of the present invention, there is provided the glass molded product as described in the first aspect,

wherein the colored layer is the same color as the resin of the frame.

According to a third aspect of the present invention, there is provided the glass molded product as described in the first or second aspect,

wherein the colored layer includes: a thermosetting resin layer which has good adhesion to the plate-like glass and is provided on the convex portion before the integral molding and is previously cured by heating; and a thermoplastic resin layer which has good adhesion to the resin constituting the frame and the thermosetting resin layer, and is provided on the thermosetting resin layer before the integral molding.

### Effect of the Invention

According to the glass molded product as described in the first aspect, when looking at the frame through the plate-like glass from the front side of the plate glass, the colored layer provided on the convex portion of the plate-like glass is observed as a background of diffuse reflection occurring at the boundary between the convex portion of the plate-like glass and the frame. Therefore, because of the color of the colored layer, the white light due to diffuse reflection is less noticeable and the appearance is improved.

According to the glass molded product as described in the second aspect, the color of the colored layer that is the background of diffuse reflection is the same color as the frame that is the further background of the colored layer. As a result, the white light due to diffuse reflection becomes less noticeable and the appearance is further improved.

According to the glass molded product as described in the third aspect, the colored layer between the plate-like glass and the frame is composed of two layers of a thermosetting resin layer with good adhesion to plate-like glass and a thermoplastic resin layer with good adhesion between the resin of the frame and the thermosetting resin layer and integrally molded. Therefore, the plate-like glass and the frame can be bonded securely and integrated.

### BRIEF DESCRIPTION OF DRAWINGS

FIG. 1 is a cross-sectional view for explaining a glass molded product proposed by the inventor of the present application and a problem discovered by the inventor of the present application in the glass molded product;

FIG. 2 is a cross-sectional view of a glass molded product according to a first embodiment of the present invention; and

FIG. 3 is a cross-sectional view of a glass molded product according to a second embodiment of the present invention.

### DESCRIPTION OF EMBODIMENTS

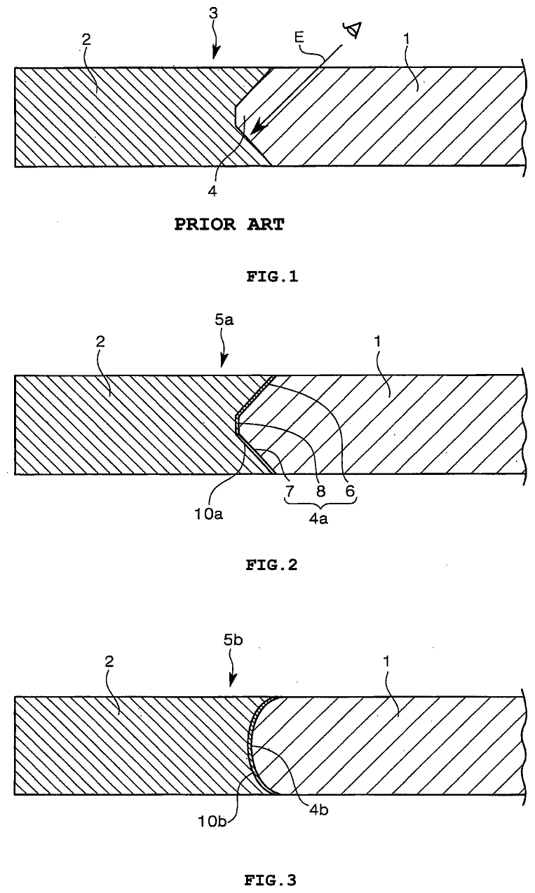

A first embodiment of the present invention will be described with reference to FIG. 2. FIG. 2 is a cross-sectional view taken along the same cross section as FIG. 1. In the glass molded product 5a of the present embodiment, the resin-made frame 2 is provided on the outer peripheral end face of the plate-like glass 1 by integral molding. There is no step between plate-like glass 1 and frame 2. Both the front and back surfaces are flat. The glass molded product 5a can be used as a cover glass for covering a device which is a component in various devices, and for example, a touch sensor can be disposed on the back surface side of the glass molded product 5a to configure an input device. A liquid crystal display can be arranged and a display device can be comprised. However, the application is not limited.

As described above, in order to realize structural feature that both front and back surfaces are flat, in the glass molded product 5a, a convex portion 4a is provided on the outer peripheral end face of the plate-like glass 1 as a structure for fixing the frame 2. The convex portion 4a includes: a front slope 6 having an inclination angle of 45 degrees with respect to the front surface; a back slope 7 having an inclination angle of 45 degrees with respect to the back surface, and a vertical surface 8 provided at the boundary between the front slope 6 and the back slope 7 so as to be perpendicular to the front and back surfaces. As shown in the figure, the convex portion 4a is shaped as if the apex of a horizontal isosceles triangle is cut. Therefore, when the center line which bisects the plate-like glass 1 in the thickness direction is assumed, the convex portion 4a is symmetrical with respect to this center line. Further, the convex portion 4a of the plate-like glass 1 is polished by a relatively rough polishing means (for example, a whetstone of about #800 or the like), and asperities (not shown) are formed on the surface of the convex portion 4a.

A frame 2 is provided on the convex portion 4a of the outer peripheral end face of the plate-like glass 1. The frame 2 is provided for covering the convex portion 4a of the plate-like glass 1 by integral molding, and has a front surface which is the same plane as the front surface of the plate-like glass 1 and a back surface which is the same plane as the back surface of the plate-like glass 1. By wrapping the convex part 4a with resin in the mold in the integral molding process, molten resin penetrates into the asperities of the surface of the convex portion 4a and solidifies to obtain an anchor effect in which the frame 2 is securely fixed to the convex portion 4a. A structure in which the frame 2 is held only by the convex portion 4a of the plate-like glass 1 is obtained. Further, as described above, since the convex portion 4 a is symmetrical with respect to the center line in the thickness direction of the plate-like glass 1, the effect that the frame 2 is fixed to the convex portion 4a becomes uniform on both sides (front side and back side) of the center line, and the structural strength is stabilized. As described above, although the frame 2 is fixed only by the convex portion 4a on the outer peripheral end face of the plate-like glass 1, sufficient strength is realized, and a flat panel on both front and back is obtained. In addition, it is preferable that the flatness of front and back is a grade which does not feel a level difference when touching with a finger. As an example for that, the step between the plate-like glass 1 and the frame 2 should just be about 20 micrometers or less, and this condition can be cleared in this embodiment.

The colored layer 10a is provided on the convex portion 4a of the plate-like glass 1. Although the color of the colored layer 10a does not include transparency, the color is not limited regardless of whether it is a chromatic color or an achromatic color. In order to provide the colored layer 10a, a colorant of a desired color is mixed with a thermoplastic adhesive, and this is applied to the convex portion 4a and dried. Thermoplastic adhesives of various colors are commercially available and may be used. In the integral molding process, the plate-like glass 1 is placed in a mold, and a resin is injected into the closed mold to wrap the convex portion 4a with the resin, and the melted adhesive and resin are mixed to fix the convex portion 4a and frame 2. Thus, a structure is obtained in which the frame 2 is held only by the outer peripheral end face of the plate-like glass 1.

According to the glass molded product 5a having such a configuration, When the frame 2 is viewed through the plate glass 1 from the front side of the plate-like glass 1, as a background of diffuse reflection occurring at the boundary between the convex portion 4a of the plate-like glass 1 and the frame 2, the colored layer 10a provided on the convex portion 4a of the plate-like glass 1 is observed. Therefore, because of the color of the colored layer 10a, the white light due to diffuse reflection becomes less noticeable, and the appearance is improved.

Although the color of the colored layer 10a is arbitrary, if the colored layer 10a is a color different from that of the frame 2, the color of the colored layer 10a can be seen on the background of diffuse reflection, so the white light by diffuse reflection becomes less noticeable, and the appearance is improved. Further, if the colored layer 10a has the same color as the frame 2, the color of the colored layer 10a serving as the background of diffuse reflection is the same color as the frame 2 serving as the background of the colored layer 10a. Therefore, the white light due to diffuse reflection is even less noticeable and the appearance is further improved. For example, when the frame 2 is black, the colored layer 10a may be black, when the frame 2 is white, the colored layer 10a may be white, and when the frame 2 is red, the colored layer 10a may be red.

If the color of the colored layer 10a is the same as that of the resin of the frame 2, the above effect can be obtained. However, when the liquid crystal display is disposed on the back side of the glass molded product 5a to constitute a display device, the color of the colored layer 10a may be the same as the color when the liquid crystal display (or other device) is not displayed. In this case, the frame 2 behind the plate-like glass 1 is less noticeable with respect to the device when the device is in the OFF state, which is preferable in terms of appearance.

In the present embodiment, the colored layer 10a is applied to the entire convex portion 4a of the plate-like glass 1. However, since it is the front slope 6 of the convex portion 4a that is a big problem in appearance, the coloring layer 10a may be provided only on the back slope 7.

In the present embodiment, the front slope 6 and the back slope 7 of the convex portion 4a respectively have an inclination angle of 45 degrees with respect to the front and back surfaces, and the convex portion 4a is stuck to the resin at an angle of approximately 90 degrees. However, the angle of the convex portion 4a pierced into the resin is further reduced, and the area in which the front slope 6 and the back slope 7 of the convex portion 4a are in contact with the resin may be further increased to further strengthen the bite of the convex portion 4a into the resin.

In the first embodiment described above, as shown in FIG. 2, the colored layer 10a is described as a single layer made of a thermoplastic adhesive mixed with a colorant. However, although it looks like a single layer after integral molding, two layers of different materials may be provided in the manufacturing process to form an adhesive layer which appears as a single component by integral molding. In this way, an example in which two kinds of materials are used to form the adhesive layer 10a will be described as a modified example of the first embodiment.

The first material provided in the convex portion 4a of plate-like glass 1 in order to form adhesion layer 10a is urethane-based thermosetting resin whose adhesiveness with glass is good. A colored ink is added to the urethane-based thermosetting resin, and thus has a function as a coloring material and an adhesive.

In order to form the adhesive layer 10a, a second layer made of a second material is provided on the first layer made of the urethane-based thermosetting resin provided on the convex portion 4a of the plate-like glass 1. The second material is a thermoplastic resin as a resin binder for adhesion, which has good adhesion to the urethane-based thermosetting resin and good adhesion to the resin (ABS, PC, acrylic, etc.) constituting the frame 2.

A manufacturing process of the glass molded product 5a using a first material and a second material will be described.

(1) A urethane-based thermosetting resin is applied to the convex portion 4a of the plate-like glass 1.

(2) The urethane-based thermosetting resin applied to the convex portion 4a is heated and cured.

(3) A thermoplastic resin as a resin binder dissolved in a solvent is applied on the cured urethane-based thermosetting resin.

(4) The solvent mixed with the thermoplastic resin is heated and volatilized. Heating is sufficient to evaporate the solvent.

(5) Similar to the first embodiment, in a mold sandwiching the plate-like glass 1, resin is injected to perform integral molding. The thermoplastic resin is melted because of thermoplasticity, and the plate-like glass 1 and the frame 2 are adhered and integrated with the thermoplastic resin as a resin binder.

The urethane-based thermosetting resin has good adhesiveness with the glass of the plate-shaped glass 1, and the thermoplastic resin has good adhesiveness with the resin that forms the frame 2, and the urethane-based thermosetting resin and the thermoplastic resin have good adhesiveness with each other. Therefore, even if there is no suitable adhesive for directly bonding the glass and the resin, according to this modified example, the effect that the plate-like glass 1 and the frame 2 can be securely bonded and integrated is obtained.

According to the manufacturing process of the present modified example, at the stage after the above step (4) is completed, that is, before the frame 2 is integrally formed, a layer of urethane-based thermosetting resin in the convex portion 4a of the plate-like glass 1 and a layer of thermoplastic resin in which the solvent is volatilized is observed as two different layers. Then, after integral molding of the above process (5) is performed, since the thermoplastic resin has thermoplasticity, the thermoplastic resin melts in contact with the injected high temperature resin and mixes with the resin. Therefore, when integral molding is completed and it becomes glass molded product 5a, it will be in the state where only the above-mentioned urethane-based thermosetting resin is visible as colored layer 10a. That is, when integral molding is completed, the colored layer 10a appears as one layer.

A second embodiment of the present invention will be described with reference to FIG. 3. FIG. 3 is a cross-sectional view taken along the same cross section as FIG. 2. In the glass molded product 5b of the present embodiment, the shape of the convex portion 4b provided on the outer peripheral end face of the plate-like glass 1 is different from the shape of the convex portion 4a of the first embodiment, therefore the shape of the colored layer 10b is also different from the shape of the colored layer 10a of the first embodiment. The other configuration and the integral molding process are the same as those in the first embodiment. As shown in FIG. 3, the convex portion 4b of the plate-like glass 1 of this embodiment is a convex curved surface whose cross section is a part of circular shape. Moreover, this convex portion 4b is a symmetrical shape about this center line, when the center line which divides the plate-like glass 1 in the thickness direction is assumed. The same effect as that of the first embodiment can be obtained also by the present embodiment.

In the embodiment described above, the convex portions 4a and 4b of the plate-like glass 1 are symmetrical to the center line and have a triangular shape (convex portion 4a, FIG. 2) from which the apex is removed and a partial circular shape (convex part 4b, FIG. 3). However, the shape is not limited to these, and in short, it may be a shape that protrudes into the resin in integral molding to sufficiently obtain a fixing force for the resin.

### REFERENCE SIGNS LIST

1 plate-like glass
2 frame
4a, 4b convex portion
5a, 5b glass molded product
10a, 10b colored layer

1. A glass molded product comprising:
a plate-like glass with a convex portion provided on an outer peripheral end face thereof;
a frame made of resin, provided by integral molding so as to cover the convex portion of the plate-like glass, and having a front surface that is flush with a front surface of the plate-like glass and a back surface that is flush with a back surface of the plate-like glass; and
a colored layer provided on the convex portion.

2. The glass molded product as claimed in claim 1,
wherein the colored layer is the same color as the resin of the frame.

3. The glass molded product as claimed in claim 1,
wherein the colored layer includes: a thermosetting resin layer which has good adhesion to the plate-like glass and is provided on the convex portion before the integral molding and is previously cured by heating; and a thermoplastic resin layer which has good adhesion to the resin constituting the frame and the thermosetting resin layer, and is provided on the thermosetting resin layer before the integral molding.

4. The glass molded product as claimed in claim 2,
wherein the colored layer includes: a thermosetting resin layer which has good adhesion to the plate-like glass and is provided on the convex portion before the integral molding and is previously cured by heating; and a thermoplastic resin layer which has good adhesion to the resin constituting the frame and the thermosetting resin layer, and is provided on the thermosetting resin layer before the integral molding.
